(19) United States
(12) Patent Application Publication
(10) Pub. No.: US 2013/0328923 A1
(43) Pub. Date: Dec. 12, 2013

(54) DIALOG NOTIFICATION

(71) Applicants: Stephen Michael Danton, Seattle, WA (US); Jonah B. Sterling, Seattle, WA (US); Jefferson King, Bellevue, WA (US); Jesse David Francisco, Lake Stevens, WA (US); Dina-Marie Ledonne Supino, Seattle, WA (US); Adam Mohamed Abdelhamed, Bellevue, WA (US); Mark S. D'Urso, Redmond, WA (US); Bharat Ahluwalia, Redmond, WA (US)

(72) Inventors: Stephen Michael Danton, Seattle, WA (US); Jonah B. Sterling, Seattle, WA (US); Jefferson King, Bellevue, WA (US); Jesse David Francisco, Lake Stevens, WA (US); Dina-Marie Ledonne Supino, Seattle, WA (US); Adam Mohamed Abdelhamed, Bellevue, WA (US); Mark S. D'Urso, Redmond, WA (US); Bharat Ahluwalia, Redmond, WA (US)

(73) Assignee: MICROSOFT CORPORATION, Redmond, WA (US)

(21) Appl. No.: 13/620,378

(22) Filed: Sep. 14, 2012

Related U.S. Application Data
(60) Provisional application No. 61/656,349, filed on Jun. 6, 2012.

(51) Int. Cl. G09G 5/00

(52) U.S. Cl. 345/629

(57) ABSTRACT

A user interface in which a notification is to be displayed in the context of a dialog already being displayed over a primary application work area. Rather than pop up an additional dialog to show the notification, the notification is displayed adjacent the existing dialog. If the notification is a confirmation request, the display of the confirmation request disables an advancement control in the dialog that would otherwise enable the user to advance to the next step in the dialog, or to close the dialog.

### CROSS-REFERENCE TO RELATED APPLICATIONS

The present application claims priority under 35 U.S.C. 119(e) to U.S. provisional application Ser. No. 61/656,349 filed Jun. 6, 2012, which provisional patent application is incorporated herein by reference in its entirety.

### BACKGROUND

Computing systems have transformed the way we work, play, and communicate, particularly with the proliferation of the Internet and other networking technologies. User interfaces allow human beings to interface with a computing system, to thereby provide input to the computer programs executing on the computing systems.

As the user interacts with an application running on a computing system, a dialog box or window (often referred to simply as a “dialog”) may often appear. The purpose of the dialog is to present information to the user, or receive information from the user, without changing the primary work area of the application. The dialog is also known as a pop up since it appears over the primary application work area. The dialog is temporary, as the dialog will be closed once its purpose is completed, and the user may return to the primary application work area.

When notifications (e.g., warnings, information, and confirmation) appear in the context of the dialog, using another dialog appears. Thus, the new dialog appears over the older dialog, which appears over the primary application work area. It is even possible to have a number of these types of nested dialogs.

### BRIEF SUMMARY

At least one embodiment described herein relates to a user interface in which a notification is to be displayed in the context of a dialog already being displayed over a primary application work area. Rather than pop up an additional dialog to show the notification, the notification is displayed adjacent the existing dialog. In one embodiment in which the notification is a confirmation request, the display of the confirmation request disables an advancement control in the dialog that would otherwise enable the user to advance to the next step in the dialog, or to close the dialog to again reveal the primary application work area. The display of the notification adjacent to the dialog is more elegant to the user and avoids the user having to deal with nested dialogs in which the order of nesting can be confusing, and sometimes one or more dialogs may be hidden from view.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a computing system in which some embodiments described herein may be employed;

FIG. 2 illustrates a flowchart of a method for displaying notifications in the context of a dialog already being displayed over a primary work area;

FIG. 3A abstractly illustrates a user interface that includes just the primary application work area with arbitrary content representing any arbitrary primary application work area;

FIG. 3B abstractly illustrates the user interface of FIG. 3A, except with a dialog appearing over a portion of the primary application work area;

FIG. 3C abstractly illustrates the user interface of FIG. 3B, but in which a notification is displayed adjacent to and abutting the dialog on the upper edge of the dialog, and in which the notification extends further to hide more of the primary application work area;

FIG. 3D abstractly illustrates the user interface of FIG. 3B, but in which a notification is displayed adjacent to and abutting the dialog on the upper edge of the dialog, and in which the notification and the dialog occupy the same area that the dialog alone did previous to the notification;

FIG. 4A illustrates a first example concrete user interface in which a dialog appears over a primary application work area;

FIG. 4B illustrates the first example concrete user interface of FIG. 4A, except in which a notification appears along with the dialog over a primary application work area;

FIG. 5A illustrates a second example concrete user interface in which a dialog appears over a primary application work area;

FIG. 5B illustrates the first example concrete user interface of FIG. 5A, except in which a notification appears along with the dialog over a primary application work area, and in which the notification includes an expansion control;

FIG. 5C illustrates another second concrete example user interface that is similar to the user interface of FIG. 5A, except that the notification is a warning related to billing impact, and in which the notification includes a contraction control; and

FIG. 5D illustrates another second concrete example user interface that is similar to the user interface of FIG. 5A, except that the notification is a confirmation request which disables and hides an advancement control in the dialog.

### DETAILED DESCRIPTION

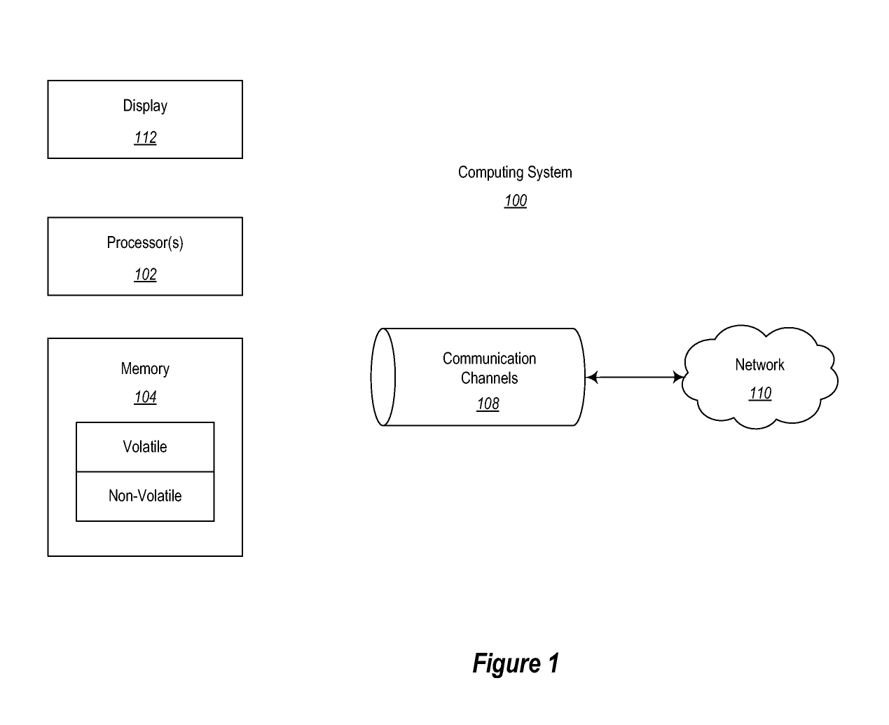

In accordance with embodiments described herein, a user interface is described in which a notification is to be displayed in the context of a dialog already being displayed over a primary application work area. Rather than pop up an additional dialog to show the notification, the notification is displayed adjacent the existing dialog. In one embodiment in which the notification is a confirmation request, the display of the confirmation request disables an advancement control in the dialog that would otherwise enable the user to advance to the next step in the dialog, or to close the dialog to again reveal the primary application work area. Some introductory discussion of a computing system will first be described with respect to FIG. 1. Then, embodiments of the user interface will be described with respect to subsequent figures.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system 100 may also have a display (such as display 112) on which user interfaces, such as the user interface described herein, may be visualized to a user.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

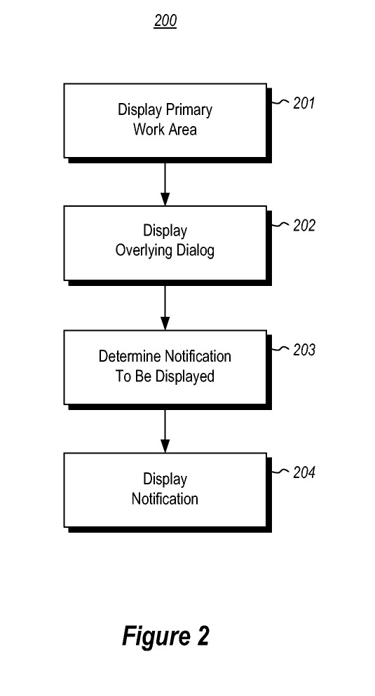

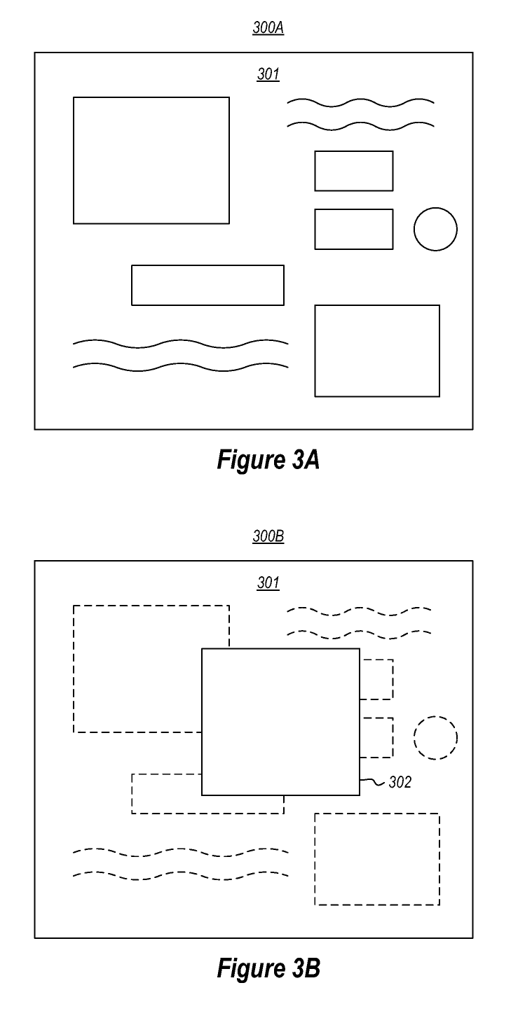

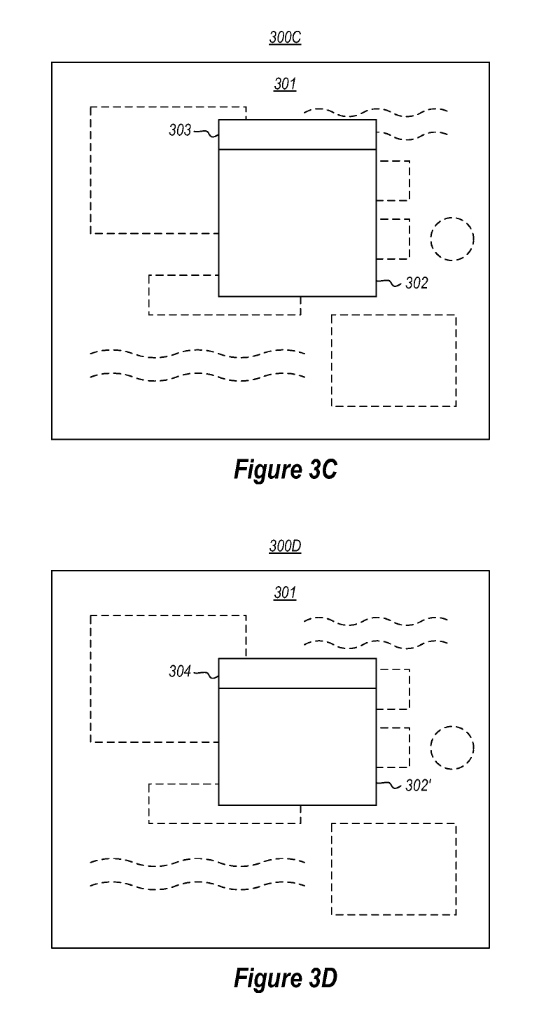

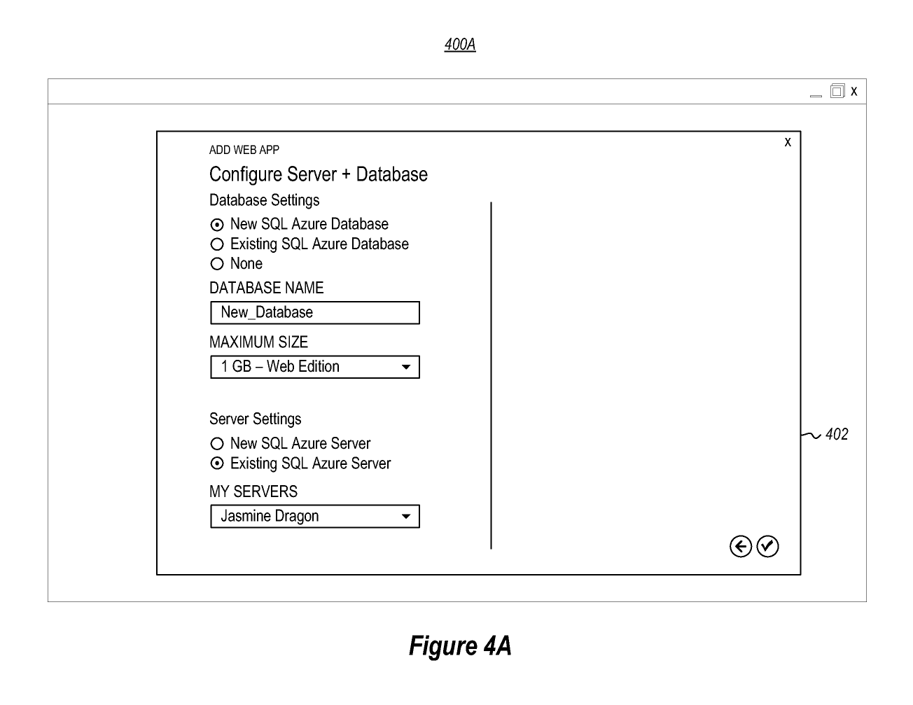

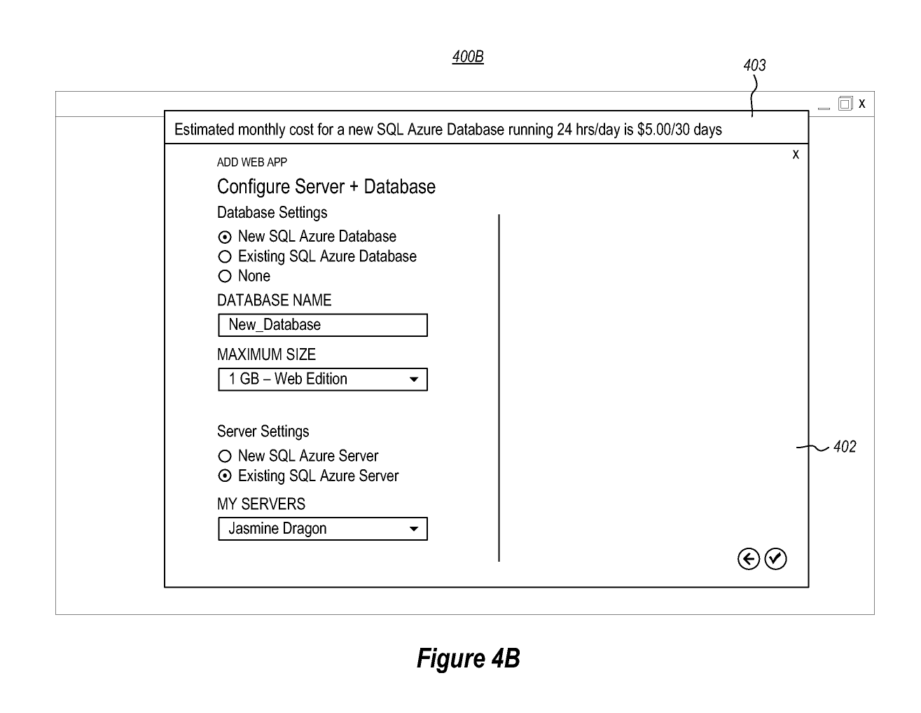

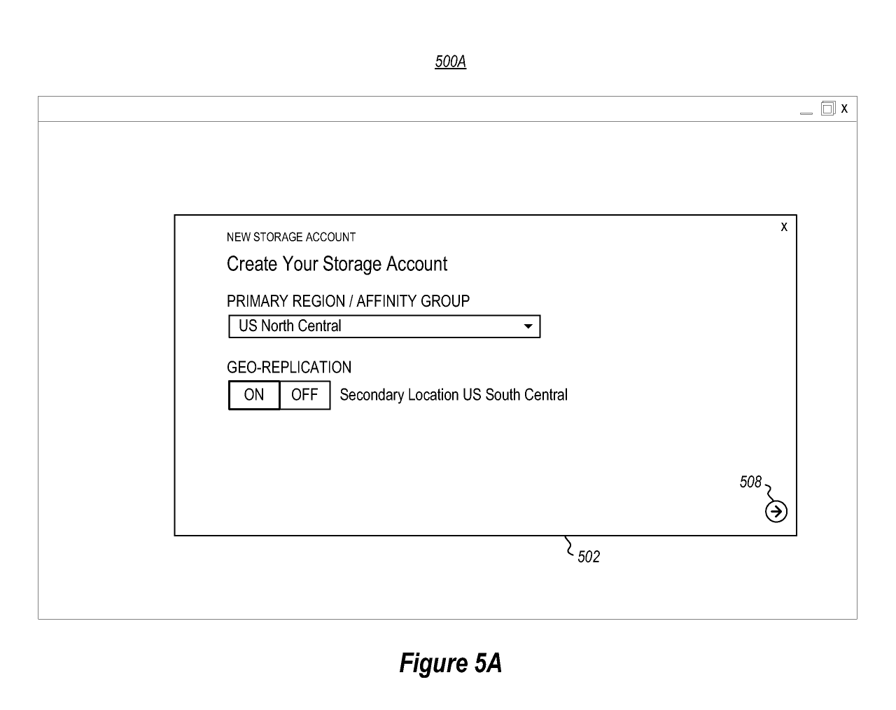

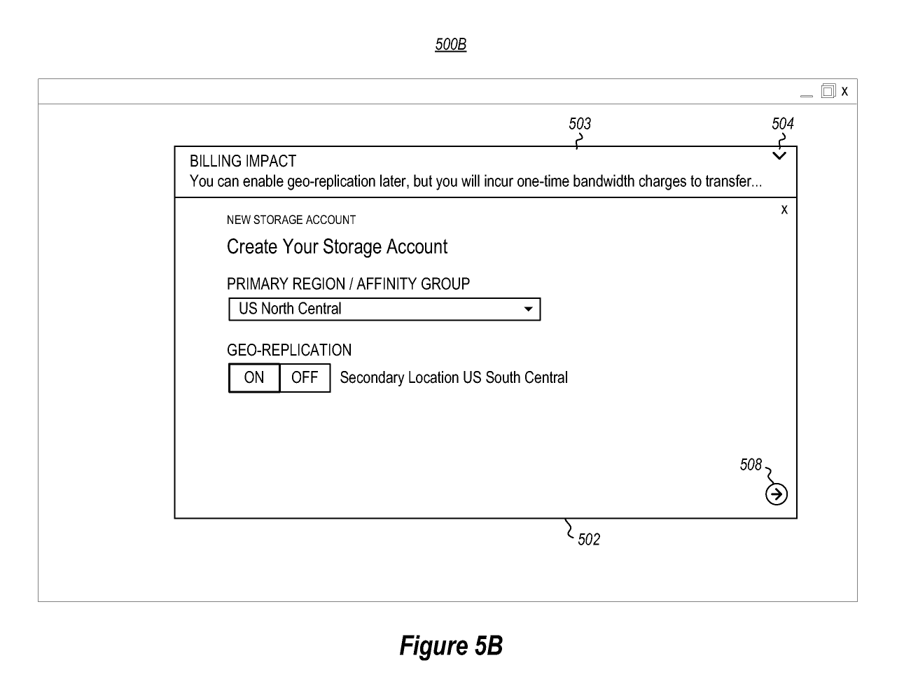

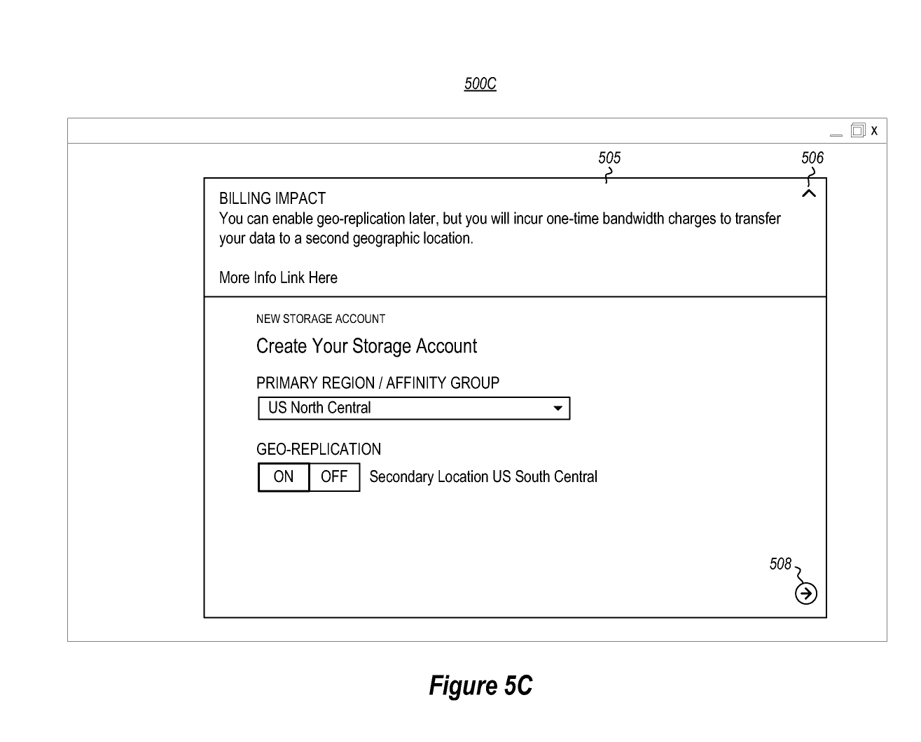

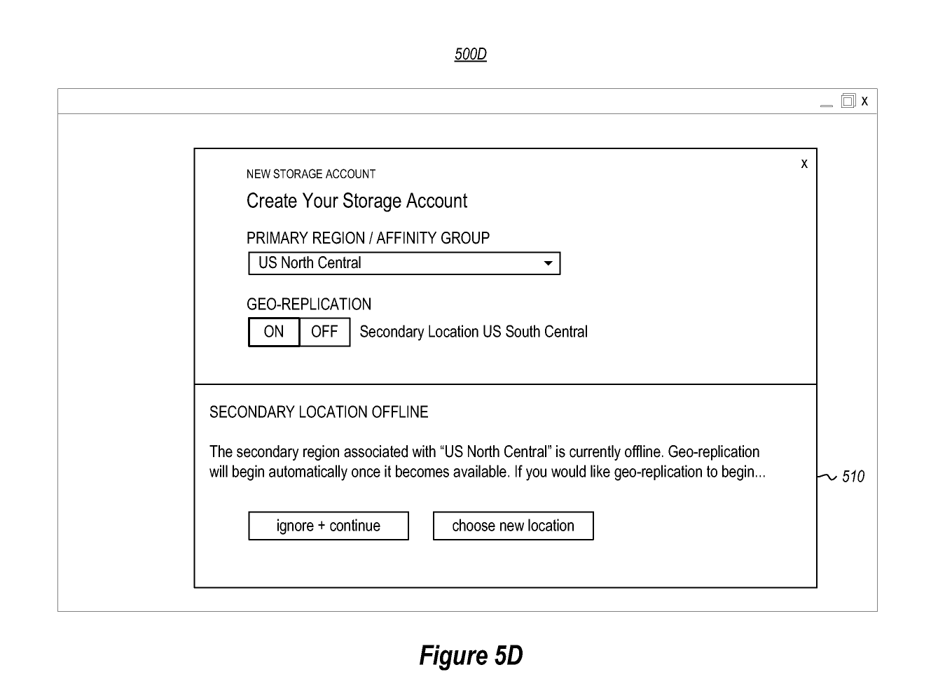

FIG. 2 illustrates a flowchart of a method 200 for displaying notifications (i.e., “dialog notifications”) in the context of a dialog already being displayed over a primary work area. The method 200 will be described with respect to the abstract examples of FIGS. 3A through 3D, and with respect to a first concrete example with respect to FIGS. 4A through 4B, and with respect to a second concrete example with respect to FIGS. 5A through 5D.

The method 200 first displays a primary application work area. This could be any work space associated with any software application or program. Examples include work processing programs, web services, web sites, e-mail programs, but extend to any application that could use dialogs. FIG. 3A abstractly illustrates a user interface 300A that includes just the primary application work area 301 with arbitrary content representing any arbitrary primary application work area.

As the user interacts with the primary application work area, a dialog is displayed over the primary application work area (act 202). Referring to the abstract example of FIG. 3B, the abstract user interface 300B appears in which the dialog 302 having any arbitrary content is displayed over the primary application work area 301. The dialog is typically displayed to display information to the user and/or query for user input. FIG. 4A illustrates a first example concrete user interface 400A in which a dialog 402 appears over a primary application work area 401. FIG. 5A illustrates a second example concrete user interface 500A in which dialog 502 appears over the primary application work area 501.

The computing system then determines that a notification is to be presented to the user (act 203). If while the dialog is displayed, no notification is ever presented to the user, then the dialog would simply close when the purpose of communication with the user is completed. However, if a notification is to be displayed (act 203), the notification is displayed adjacent and abutting the dialog (act 204.

FIG. 3C illustrates a user interface 300C in which a notification 303 is displayed adjacent to and abutting the dialog 302 on the upper edge of the dialog 302. In FIG. 3C, the combination of the notification 303 and the dialog are rectangular, although the notification 303 extends from a border of the dialog 202 to further hide the primary application work area.

FIG. 3D illustrates an alternative user interface 300D in which a notification 304 is displayed adjacent to and abutting the dialog 302′ on the upper edge of the dialog 302′. In FIG. 3D, the combination of the notification 304 and the dialog are rectangular, although the combination of the notification 304 and the dialog 302′ after the notification is displayed occupy the same space that the dialog 302 alone occupied before the notification. In this case, the dialog 302 is contracted slightly to form contracted dialog 302′. In a hybrid of FIGS. 3C and 3D, the notification may be displayed by partly contracting the size of the dialog, while slightly enlarging the combination of the dialog and notification as compared to the previous notification. The notification may be displayed abutting any edge (left, right, upper, lower) of the dialog.

By displaying the dialog notifications so that they do not overlap the dialog, the user is able to maintain their focus and awareness of the primary task (i.e., completing the dialog) while still being made aware of new information or input requests as appropriate. Furthermore, adjacent notification ensures the user sees the notification, but also to encourage the user to maintain focus on the dialog.

FIG. 4B illustrates the first concrete example user interface 400B that is similar to the user interface 400A of FIG. 4A, except that notification 403 appears adjacent to and abutting the dialog 402. In this case, the notification is an informational notification showing the billing impact resulting from some user interaction with the dialog 402.

FIG. 5B illustrates a second concrete example user interface 500B that is similar to the user interface 500A of FIG. 5A, except that notification 503 appears adjacent to and abutting the dialog 502. In this case, the notification is a warning relating to billing impact. In addition, the notification includes an expansion control 504 to further expand the notification area for further notification details.

FIG. 5C illustrates another second concrete example user interface 500C that is similar to the user interface 500A of FIG. 5A, except that notification 505 appears adjacent to and abutting the dialog 502. In this case, the notification is again a warning relating to billing impact. In addition, the notification 505 includes a contraction control 506 to reduce the notification area for less notification detail. In one embodiment, the selection of the expansion control 504 of FIG. 5B results in the user interface 500C of FIG. 5C, and the selection of the contraction control 506 of FIG. 5C results in the user interface 500B of FIG. 5B.

FIG. 5D illustrates another second concrete example user interface 500C that is similar to the user interface 500A of FIG. 5A, except that notification 510 appears adjacent to and abutting the dialog 502. The notification comprises a confirmation request. The confirmation request hides and disables an advancement control for advancing the dialog to a next step, or for closing the dialog. Specifically, the confirmation request hides the advancement control 508 (see FIG. 5A) by overlapping area previously displayed by the advancement control. Once the user provides input that satisfies the confirmation request, the confirmation request notification may be removed, allowing the advancement control of the dialog to again appear. This helps the user understand the purpose of the notification, and also ensures that there is no confusion around whether the user can continue without addressing this notification.

This dialog notification user interface allows the user to focus their attention on the specific task, while still maintaining a strong indication of new information or input. Furthermore, by ensuring that notifications are presented adjacent to the user context, but still within that context, the user is unburdened from the task of managing another window. In addition, the adjacent context approach allows for a summary and detail view to be presented to the user. This not only makes the experience less jarring, but it also ensures that familiar users can move through the system more quickly—they see the notification in its summary form, and can quickly action on it—there is no need to ever see the detail form. Furthermore, when notifications are manifested in the system, they are done so relative to very specific locations. These locations are chosen to ensure the user naturally understands the reason for the notification. This is very unlike classic notification approaches which are manifested in a generic and disconnected way, requiring the user to make the association entirely on their own.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer-readable storage media having thereon computer-executable instructions that are structured such that, when executed by one or more processors of a computing system, cause the computing system to perform a method for displaying a notification in the context of the dialog, the method comprising:
an act of displaying a primary application work area;
an act of displaying a dialog over the application work area;
an act of determining that a notification is to be presented to the user while the dialog is still displayed; and
in response to determining, an act of displaying the notification adjacent and abutting the dialog.

2. The computer program product in accordance with claim 1, wherein the notification and the dialog together form a rectangle.

3. The computer program product in accordance with claim 1, wherein the notification and the dialog together occupy the same space after the notification is displayed that the dialog alone occupied before the notification.

4. The computer program product in accordance with claim 1, wherein the notification extends from a border of the dialog to further hide the primary application work area.

5. The computer program product in accordance with claim 1, wherein the notification comprises a warning.

6. The computer program product in accordance with claim 1, wherein the notification comprises a presentation of information.

7. The computer program product in accordance with claim 1, wherein the notification comprises a confirmation request.

8. The computer program product in accordance with claim 7, wherein the dialog comprises an advancement control for advancing the dialog to a next step, or for closing the dialog, wherein the act of displaying the confirmation request disables the advancement control.

9. The computer program product in accordance with claim 8, wherein the confirmation request hides the advancement control by overlapping area previously displayed by the advancement control.

10. The computer program product in accordance with claim 7, wherein the advancement control is again enabled upon the user confirming in response to the confirmation request.

11. The computer program product in accordance with claim 1, wherein the notification includes an expansion control to further expand the notification area for further notification details.

12. The computer program product in accordance with claim 1, wherein the notification includes a contraction control to reduce the notification area for less notification detail.

13. A computer implemented method for displaying a notification in the context of the dialog being already displayed on a display of a computing system, the method comprising:
an act of displaying a primary application work area on the display;
an act of displaying a dialog over the application work area on the display;
an act of the computing system determining that a notification is to be presented to the user while the dialog is still displayed; and
in response to determining, an act of displaying the notification adjacent and abutting the dialog on the display.

14. The method in accordance with claim 13, wherein the notification and the dialog together occupy the same space after the notification is displayed that the dialog alone occupied before the notification.

15. The method in accordance with claim 13, wherein the notification extends from a border of the dialog to further hide the primary application work area.

16. The method in accordance with claim 13, wherein the notification comprises a warning.

17. The method in accordance with claim 13, wherein the notification comprises a confirmation request.

18. The method in accordance with claim 17, wherein the dialog comprises an advancement control for advancing the dialog to a next step, or for closing the dialog, wherein the act of displaying the confirmation request disables the advancement control, wherein the advancement control is again enabled upon the user confirming in response to the confirmation request.

19. The method in accordance with claim 18, wherein the confirmation request hides the advancement control by overlapping area previously displayed by the advancement control.

20. A computer implemented method for displaying a notification in the context of the dialog being already displayed on a display of a computing system, the method comprising:
an act of displaying a primary application work area on the display;
an act of displaying a dialog over the application work area on the display, the dialog comprising an advancement control for advancing the dialog to a next step, or for closing the dialog so that the underlying primary application work area is again revealed;
an act of the computing system determining that a confirmation request is to be presented to the user while the dialog is still displayed; and
in response to determining, an act of displaying the confirmation request adjacent and abutting the dialog on the display,
disabling the advancement control upon display the confirmation request;
an act of receiving confirmation from the user responsive to the confirmation request;
in response to receiving confirmation from the user, an act of closing the confirmation request, and an act of enabling the advancement control.
